(19) United States
(12) Patent Application Publication
(10) Pub. No.: US 2019/0196403 A1
(43) Pub. Date: Jun. 27, 2019

(54) HOLOGRAPHIC DISPLAY APPARATUS AND METHOD FOR DISPLAY BY USING THE SAME

(71) Applicant: BOE Technology Group Co., Ltd., Beijing (CN)

(72) Inventors: Feng GUAN, Beijing (CN); Xue DONG, Beijing (CN); Xin GU, Beijing (CN); Meili WANG, Beijing (CN); Wei WANG, Beijing (CN); Jifeng TAN, Beijing (CN)

(21) Appl. No.: 15/751,626

(22) PCT Filed: Jul. 18, 2017
(86) PCT No.: PCT/CN2017/093361

§ 371 Date: Feb. 9, 2018

(30) Foreign Application Priority Data
Sep. 8, 2016 (CN) 201610809632.1

(51) Int. Cl. G03H 1/22; G03H 1/02; G02B 26/06

(52) U.S. Cl. CPC G03H 1/2286; G03H 1/2294; G03H 2001/0224; G02B 26/06; G03H 1/02

(57) ABSTRACT

The present disclosure relates to a holographic display apparatus and a method for display by using the same. The holographic display apparatus comprises: a display device, wherein the display device comprises pixels, the pixel contains a light-emitting component, and in each pixel, an amplitude of a light wave emitted from the light-emitting component is independently adjustable; and a phase-controlling plate, wherein the phase-controlling plate is located at a position between the light-emitting component and a light emergence surface of the display apparatus, so that a phase of the light wave emitted from the light-emitting component in each pixel, when the light wave arrives the light emergence surface, is independently adjustable by the phase-controlling plate.

### CROSS-REFERENCE TO RELATED APPLICATION

This application claims the priority and benefits of Chinese Patent Application No. 201610809632.1 filed on Sep. 8, 2016, the contents of which are incorporated as a part of this application by reference in its entirety.

### TECHNICAL FIELD

This disclosure relates to the technical field of three-dimensional (3D) display, and particularly to a holographic display apparatus and a method for display by using the same.

### BACKGROUND ART

Display delivers information to people by means of vision, and thus plays an important role in true life of people. According to scientific estimation, 70% to 80% of the information obtained by people derives from vision.

3D display plays an important role in nowaday social life. Holographic display would be the most promising technology to actualize true 3D display. Holographic display can provide all information of an object wave, exhibits extremely good depth and parallax, and can provide all indications about 3D information needed by people in physiology and psychology.

The method for recording and reproducing an object wave by using interference and diffraction characteristics of light waves is referred to as holography. Since the information for the phase and amplitude of an image of an object is recorded, the 3D image of the image of the object can be reproduced. Existing holographic display systems modulate the phase and amplitude of light simultaneously by using an optically or electrically addressed spatial modulator. It is required that the spatial modulator has a high refreshing frequency and a rapid responding speed. The requirements are hardly to be satisfied. Therefore, problems, such as large crosstalk, low resolution, a tendency of causing visual fatigue, or the like, will occur, which is be adverse to achieve an optimal 3D effect by viewing.

### SUMMARY

In view of above, examples of the present disclosure provide a holographic display apparatus and a method for display by using the same.

Thus, an example of the present disclosure provides a holographic display apparatus, comprising:

a display device, wherein the display device comprises pixels, wherein the pixel contains a light-emitting component, and in each pixel, an amplitude of a light wave emitted from the light-emitting component is independently adjustable; and

a phase-controlling plate, wherein the phase-controlling plate is located at a position between the light-emitting component and a light emergence surface of the display apparatus, so that a phase of the light wave emitted from the light-emitting component in each pixel, when the light wave arrives the light emergence surface, is independently adjustable by the phase-controlling plate.

In a possible embodiment, in the holographic display apparatus provided in an example of the present disclosure, the light-emitting component of the display device is a back light source emitting coherent reference light, and an amplitude of the coherent reference light is modulated by an optical switch device disposed on a light emergence side of the back light source.

In a possible embodiment, in the holographic display apparatus provided in an example of the present disclosure, the optical switch device comprises: an upper substrate and a lower substrate, which are disposed oppositely, and a micro-electromechanical system, which is disposed between the upper substrate and the lower substrate.

In a further possible embodiment, the phase-controlling plate is disposed between the upper substrate and the micro-electromechanical system; or the phase-controlling plate is disposed between the micro-electromechanical system and the lower substrate; or the phase-controlling plate is disposed between the lower substrate and the back light source.

In a possible embodiment, in the holographic display apparatus provided in an example of the present disclosure, the optical switch device comprises: an opposite substrate and an array substrate, which are disposed oppositely, a liquid crystal layer, which is disposed between the opposite substrate and the array substrate, an upper polarizer, which is disposed above the opposite substrate, and a lower polarizer, which is disposed below the array substrate.

In a further possible embodiment, the phase-controlling plate is disposed between the upper polarizer and the opposite substrate; or the phase-controlling plate is disposed between the opposite substrate and the liquid crystal layer; or the phase-controlling plate is disposed between the liquid crystal layer and the array substrate; or the phase-controlling plate is disposed between the array substrate and the lower polarizer; or the phase-controlling plate is disposed between the lower polarizer and the back light source; or the phase-controlling plate serves as the upper polarizer or the lower polarizer.

In a possible embodiment, in the holographic display apparatus provided in an example of the present disclosure, the coherent reference light is coherent collimated light.

In a possible embodiment, in the holographic display apparatus provided in an example of the present disclosure, the display device comprises an electroluminescent display panel, and an antireflecting polarizer is disposed on a light emergence side of the electroluminescent display panel.

In a further possible embodiment, in the holographic display apparatus provided in an example of the present disclosure, the antireflecting polarizer is the phase-controlling plate.

In a possible embodiment, in the holographic display apparatus provided in an example of the present disclosure, the phase-controlling plate comprises a plurality of modulating zones independent from each other, and

the modulating zones correspond to the pixels in the display device one-to-one; or

each of the modulating zones corresponds to a plurality of pixels in the display device and modulates a phase of the light wave in each pixel by associating with an optical path difference.

In a possible embodiment, in the holographic display apparatus provided in an example of the present disclosure, modulation angles of phases in two adjacent modulating zones during light modulation are different from each other.

In a possible embodiment, in the holographic display apparatus provided in an example of the present disclosure, a phase modulation angle of a light wave in each of the modulating zones of the phase-controlling plate is fixed.

In a possible embodiment, in the holographic display apparatus provided in an example of the present disclosure, a phase modulation angle of a light wave in each of the modulating zones of the phase-controlling plate is changeable.

In a possible embodiment, in the holographic display apparatus provided in an example of the present disclosure, the phase-controlling plate is a grating phase-controlling plate, an optical-layer-thickness-type phase-controlling plate, or a liquid crystal phase-controlling plate.

In another aspect, an example of the present disclosure further provides a method for display by using the holographic display apparatus mentioned above, comprising:

modulating the amplitude of the light wave by using the display device; and

modulating the phase of the light wave by using the phase-controlling plate.

The advantageous effects of the examples of the present disclosure may include that independent control of the phase information of the light wave and the amplitude information of the light wave is achieved due to that the phase modulation and the amplitude are provided separately, and that it is beneficial to improve the ability to control the object to be modulated and thus to achieve holographic display having high quality that the amplitude information of the light wave is modulated by a display device and the phase modulation is modulated by a phase-controlling plate. Additionally, since the phase modulation may be modulated by a phase-controlling plate, multi-viewing angles naked-eye 3D display can be actualized. This apparatus may at least partially solve the current problem that the 3D viewing effect is poor due to that holographic display is achieved by a spatial modulator.

### DESCRIPTION OF DRAWINGS

FIG. 1 is a schematic of the structure of a holographic display apparatus provided in an example of the present disclosure.

FIG. 2 is a schematic of the structure of another holographic display apparatus provided in an example of the present disclosure.

FIG. 3 is a schematic of the structure of another holographic display apparatus provided in an example of the present disclosure.

FIG. 4 is a schematic of the operating principle of a micro-electromechanical system.

FIG. 5 is a schematic of the process, in which holographic display is performed by a holographic display apparatus provided in an example of the present disclosure.

### DESCRIPTION OF EMBODIMENTS

Embodiments of the holographic display apparatus provided by examples of the present disclosure and the method for display by using the same will be described in details below in conjunction with accompanying drawings.

Shapes and sizes of the components in the drawings do not exhibit the true scale of the holographic display apparatus. The purpose of the drawings is to describe the present disclosure schematically.

An example of the present disclosure provides a holographic display apparatus as shown in FIG. 1, which comprises a display device 100 for modulating amplitude information of a light wave, and a phase-controlling plate 200 for modulating phase information of a light wave, wherein the phase-controlling plate 200 is provided within the display device 100. Particularly, it comprises a display device 100, wherein the display device comprises pixels, the pixel contains a light-emitting component 110, and in each pixel, an amplitude of a light wave emitted from the light-emitting component is independently adjustable; and a phase-controlling plate 200, wherein the phase-controlling plate is located at a position between the light-emitting component and a light emergence surface of the display apparatus, so that a phase of the light wave emitted from the light-emitting component in each pixel, when the light wave arrives the light emergence surface, is independently adjustable by the phase-controlling plate.

Please note, although a separate pixel is not shown in the figure, it should be understood that the layer structure uniformly shown in the figure may comprises a plurality of independent pixels.

Particularly, in an above-mentioned holographic display apparatus in examples of the present disclosure, independent control of the phase information of the light wave and the amplitude information of the light wave is achieved due to that the phase modulation and the amplitude are provided separately, and it is beneficial to improve the ability to control the object to be modulated and thus to achieve holographic display having high quality that the amplitude information of the light wave is modulated by a display device 100 and the phase modulation is modulated by a phase-controlling plate 200. Additionally, since the phase modulation may be modulated by a phase-controlling plate, multi-viewing angles naked-eye 3D display can be actualized.

In specific embodiments, the display device 100 in an above-mentioned holographic display apparatus provided in an example of the present disclosure may be actualized by various manners, for example, by using an optical switch device for modulating amplitude information of a light wave in a passive luminescence configuration, or by using a light-emitting device capable of modulating amplitude information of a light wave in an active luminescence configuration. The manner is not limited herein.

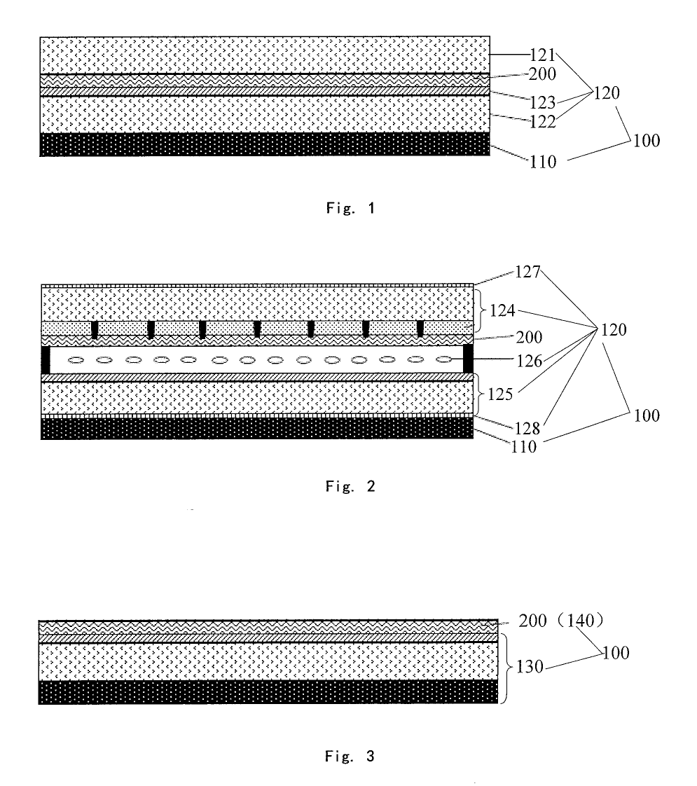

Particularly, in an above-mentioned holographic display apparatus provided in an example of the present disclosure, when amplitude information of a light wave is modulated by using an optical switch device in a non-active luminescence configuration, as shown in FIG. 1 and FIG. 2, the display device 100 typically needs to comprise a back light source 110 for providing coherent reference light, and an optical switch device 120 for modulating grey scale information of the coherent reference light disposed at the light emergence side of the back light source 110.

Particularly, in an above-mentioned holographic display apparatus provided in an example of the present disclosure, the back light source 110 for providing coherent reference light may be actualized by using an OLED back light source, by using a LED back light source, by using a dynamic back light source, or the like. The back light source is not limited herein. Further, preferably, in order to facilitate occurrence of interference and diffraction of the coherent reference light, in an above-mentioned holographic display apparatus provided in an example of the present disclosure, the coherent reference light provided by the back light source 110 is preferably coherent collimated light, i.e. the back light source 110 is preferably a collimated back light source.

Particularly, in an above-mentioned holographic display apparatus provided in an example of the present disclosure, the optical switch device 120 for modulating gray scale information of the coherent reference light may be actualized in various manners, for example, by using a device modulating amplitude information of a light wave according to received modulating signals, such as a micro-electromechanical system (MEMS) device, a liquid crystal device, an electrochromic device, an photochromic device, or the like.

Particularly, in an above-mentioned holographic display apparatus provided in an example of the present disclosure, when a MEMS is used for the optical switch device 120 in the display device 100, as shown in FIG. 1, the optical switch device 120 specifically comprises an upper substrate 121 and a lower substrate 122, which are disposed oppositely, and a micro-electromechanical system 123, which is disposed between the upper substrate 121 and the lower substrate 122.

In this case, since the phase-controlling plate 200 is at a position between the light-emitting component and the light emergence surface of the display apparatus, or in other words, disposed within the display device 100, the phase-controlling plate 200 may be disposed between the upper substrate 121 and the micro-electromechanical system 123; or the phase-controlling plate 200 may also be disposed between the micro-electromechanical system 123 and the lower substrate 122; or the phase-controlling plate 200 may also be disposed between the lower substrate 122 and the back light source 110, as shown specifically in FIG. 1. A certain position is not limited herein.

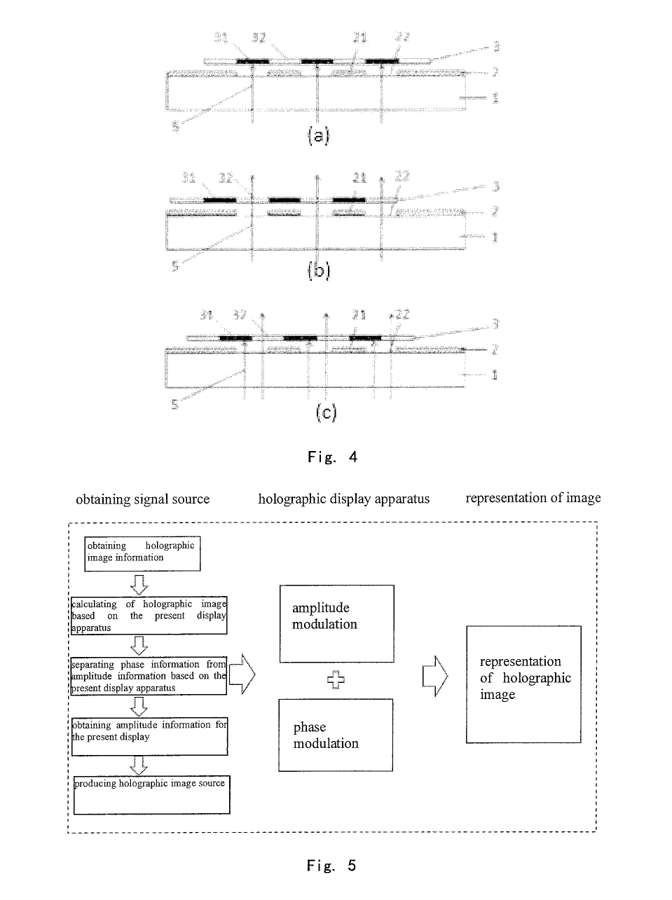

The structure an operating principle of a kind of MEMS may be shown in FIG. 4 schematically. The reference numerals in the figure represent: 1 glass; 2 immobile plate; 3 mobile plate; 31 light-blocking region of the mobile plate; 32 opening region of the mobile plate; 21 light-blocking region of the immobile plate; 22 opening region of the mobile plate; and 5 back light. Figure a shows a shut off state, Fig b shows an open state, and Figure c shows that part of light passes a pixel region during shutting off. Grey scale information of the light emitted from the back light source may be controlled by a MEMS. Modulation of amplitude is based on the grey scale control by the MEMS, i.e. switching frequency of a light valve. Additionally, RGB may be actualized on the basis of switching of the back light source.

Particularly, in an above-mentioned holographic display apparatus provided in an example of the present disclosure, when a liquid crystal display device is used for the optical switch device 120 in the display device 100, as shown in FIG. 2, the optical switch device 120 specifically comprises an opposite substrate 124 and an array substrate 125, which are disposed oppositely, a liquid crystal layer 126, which is disposed between the array substrate 125 and the opposite substrate 124, an upper polarizer 127, which is disposed above the opposite substrate 124, and a lower polarizer 128, which is disposed below the array substrate 125. Particularly, the crystal molecule in the liquid crystal layer 126 may use nematic liquid crystal, ferroelectric liquid crystal, blue phase liquid crystal, cholesteric liquid crystal, etc.

In this case, the phase-controlling plate 200 is at a position between the light-emitting component and the light emergence surface of the display apparatus, or in other words, disposed within the display device 100. Thus, in particular, the phase-controlling plate 200 may be disposed between the upper polarizer 127 and the opposite substrate 124; or as shown in FIG. 2, the phase-controlling plate 200 may also be disposed between the opposite substrate 124 and the liquid crystal layer 126; or the phase-controlling plate 200 may also be disposed between the liquid crystal layer 126 and the array substrate 125; or the phase-controlling plate 200 may also be disposed between the array substrate 125 and the lower polarizer 128; or the phase-controlling plate 200 may also be disposed between the lower polarizer 128 and the back light source 110; or the phase-controlling plate 200 may directly serve as the upper polarizer 127 or the lower polarizer 128, that is, the upper polarizer 127 or the lower polarizer 128 are not provided individually.

Particularly, in an above-mentioned holographic display apparatus provided in an example of the present disclosure, when another device, such as an electrochromic device, an photochromic device, or the like, is used as the optical switch device 120 in the display device 100, similarly to the MEMS device and the liquid crystal display device, the phase-controlling plate 200 may be disposed within the device 120, or it may be disposed between the optical switch device 120 and the back light source 110. Description in details is omitted herein.

Particularly, in an above-mentioned holographic display apparatus provided in an example of the present disclosure, when an active luminescence configuration is used, a light-emitting device capable of modulating amplitude information of a light wave may be used as the display device 100, as shown in FIG. 3, wherein the display device 100 may specifically comprise an electroluminescent display panel 130, and an antireflecting polarizer 140, which is disposed at the light emergence side of the electroluminescent display panel 130. In this case, the phase-controlling plate 200 may be disposed within the electroluminescent display panel 130, or as shown in FIG. 3, the phase-controlling plate 200 is used directly as an antireflecting polarizer 140, i.e. an antireflecting polarizer 140 is not provided separately.

In a specific embodiment, for the purpose of modulating the phase information of the light wave, in an above-mentioned holographic display apparatus provided in an example of the present disclosure, the phase-controlling plate 200 typically comprises a plurality of modulating zones independent from each other, and the modulating zones correspond to the pixels in the display device 100 one-to-one; or each of the modulating zones corresponds to a plurality of pixels in the display device 100 one-to-one. How to correspond is not limited herein. In the latter case, as an example, each of the modulating zones corresponds to a plurality of pixels in the display device, and modulates a phase of the light wave in each pixel by associating with an optical path difference.

Further, in an above-mentioned holographic display apparatus provided in an example of the present disclosure, modulation angles of phases in two adjacent modulating zones in the phase-modulating plate 200 during light modulation are generally different from each other, wherein the modulation ability in modulating the phase angle is generally controlled in 0-2π, i.e. the scope of the phase modulation angle is selected in 0-2π.

In an specific embodiment, in order to actualize display of a dynamic holographic image, in an above-mentioned holographic display apparatus provided in an example of the present disclosure, holographic display may be actualized specifically by the following three manners. In the first manner, amplitude information of a light wave is modulated to change dynamically, while the phase modulation angle for modulating phase information of the light wave is relatively fixed. In the second manner, amplitude information of a light wave is modulated to change dynamically, while the phase modulation angle for modulating phase information of the light wave also changes dynamically according to the change of the viewing angle. In the third manner, amplitude information of a light wave is modulated to be relatively fixed, while dynamic holographic display is actualized by the phase modulation angle for modulating phase information of the light wave. On the basis of above, in an above-mentioned holographic display apparatus provided in an example of the present disclosure, a phase modulation angle of a light wave in each of the modulating zones of the phase-controlling plate 200 may be fixed, or, may also be changeable, for example, may change dynamically according to a received amplitude modulation signals.

Particularly, in an above-mentioned holographic display apparatus provided in an example of the present disclosure, according to whether the phase modulation angle in each of modulating zones in the phase-controlling plate 200 is need to be adjusted dynamically, a specific embodiment of the phase-modulating plate 200 may be selected. For example, when the phase modulation angle for modulating a light wave in each modulating zone in the phase-modulating plate 200 is relatively fixed, a grating phase-controlling plate, an optical-layer-thickness-type phase-controlling plate, or a liquid crystal phase-controlling plate may be selected to be the phase-modulating plate 200. When the phase modulation angle for modulating a light wave in each modulating zone in the phase-modulating plate 200 needs to change dynamically, a liquid crystal phase-controlling plate may be selected to be the phase-modulating plate 200.

In these cases, particularly, a grating phase-controlling plate refers to nanometer gratings with different grating periods provided in each modulating zone in the phase-controlling plate 200, so as to perform phase angle modulation with different extent on the phase information of the light wave passing therethrough. An optical-layer-thickness-type phase-controlling plate refers to a stack of thin films with different thicknesses provided in each modulating zone in the phase-controlling plate 200, so as to perform phase angle modulation with different extent on the phase information of the light wave passing therethrough. A liquid crystal phase-controlling plate refers to separately controllable liquid crystal cells provided in each modulating zone in the phase-controlling plate 200, so as to perform phase angle modulation with different extent on the phase information of the light wave passing therethrough by controlling the rotating angle of the liquid crystal molecules in the liquid crystal cell.

On the basis of the same inventive concept, an example of the present disclosure also provided a method for display by using the holographic display. Since the principle of the method for display to solve problems is similar to that of the above-mentioned holographic display apparatus, the embodiments of the holographic display apparatus may be used to explain the embodiments of the method for display. The repeated portion is not described in details again.

In particular, an example of the present disclosure also provided a method for display by using the holographic display comprises following steps, to actualize holographic display: modulating the amplitude of the light wave by using the display device; and modulating the phase of the light wave by using the phase-controlling plate. The modulation may be performed according to received modulating signals. When a dynamic phase-controlling plate is used, dynamic holographic display may be actualized.

In an embodiment, the signal source may be divided into amplitude information and phase amplitude, according to the desired holographic image information to be displayed. Thereafter, the modulation information is loaded onto the modulating signal, which is sent to the display device, to carry out the modulation. Meanwhile, it is also possible to control the phase-controlling plate according to phase information, or modulate phase information of a light wave by a phase-controlling plate using fixed modulation. Reproduction of a holographic image may be actualized by adjusting amplitude information of a light wave by the display device, while adjusting phase information of a light wave by the phase-modulating plate. A specific process may be as shown in FIG. 5.

The above-mentioned holographic display apparatus and the method for display by using the same provided in examples of the present disclosure comprise a display device for modulating amplitude information of a light wave, and a phase-controlling plate for modulating phase information of a light wave, wherein the phase-controlling plate is provided in the display device. Independent control of the phase information of the light wave and the amplitude information of the light wave is achieved due to that the phase modulation and the amplitude are provided separately, and that it is beneficial to improve the ability to control the object to be modulated and thus to achieve holographic display having high quality that the amplitude information of the light wave is modulated by a display device and the phase modulation is modulated by a phase-controlling plate. Additionally, since the phase modulation may be modulated by a phase-controlling plate, multi-viewing angles naked-eye 3D display can be actualized.

It is apparent that those skilled in the art may implement various changes and modification of the present disclosure without departing the spirit and scope of the present disclosure. Thus, if these changes and modifications of the present disclosure pertain to the scope of the claims of the present disclosure and the equivalent technology thereof, the present disclosure intends to include these changes and modifications.

1. A holographic display apparatus, comprising:
a display device, wherein the display device comprises pixels, wherein the pixel contains a light-emitting component, and in each pixel, an amplitude of a light wave emitted from the light-emitting component is independently adjustable; and
a phase-controlling plate, wherein the phase-controlling plate is located at a position between the light-emitting component and a light emergence surface of the display apparatus, so that a phase of the light wave emitted from the light-emitting component in each pixel, when the light wave arrives the light emergence surface, is independently adjustable by the phase-controlling plate.

2. The holographic display apparatus of claim 1, wherein
the light-emitting component of the display device is a back light source emitting coherent reference light, and an amplitude of the coherent reference light is modulated by an optical switch device disposed on a light emergence side of the back light source.

3. The holographic display apparatus of claim 2, wherein the optical switch device comprises:
an upper substrate and a lower substrate, which are disposed oppositely, and
a micro-electromechanical system, which is disposed between the upper substrate and the lower substrate.

4. The holographic display apparatus of claim 3, wherein the phase-controlling plate is disposed between the upper substrate and the micro-electromechanical system; or the phase-controlling plate is disposed between the micro-electromechanical system and the lower substrate; or the phase-controlling plate is disposed between the lower substrate and the back light source.

5. The holographic display apparatus of claim 2, wherein the optical switch device comprises:
an opposite substrate and an array substrate, which are disposed oppositely,
a liquid crystal layer, which is disposed between the opposite substrate and the array substrate,
an upper polarizer, which is disposed above the opposite substrate, and
a lower polarizer, which is disposed below the array substrate.

6. The holographic display apparatus of claim 5, wherein the phase-controlling plate is disposed between the upper polarizer and the opposite substrate; or the phase-controlling plate is disposed between the opposite substrate and the liquid crystal layer; or the phase-controlling plate is disposed between the liquid crystal layer and the array substrate; or the phase-controlling plate is disposed between the array substrate and the lower polarizer; or the phase-controlling plate is disposed between the lower polarizer and the back light source; or the phase-controlling plate serves as the upper polarizer or the lower polarizer.

7. The holographic display apparatus of claim 2, wherein the coherent reference light is coherent collimated light.

8. The holographic display apparatus of claim 1, wherein the display device comprises an electroluminescent display panel, and an antireflecting polarizer is disposed on a light emergence side of the electroluminescent display panel.

9. The holographic display apparatus of claim 8, wherein the antireflecting polarizer is the phase-controlling plate.

10. The holographic display apparatus of claim 1, wherein the phase-controlling plate comprises a plurality of modulating zones independent from each other, and
the modulating zones correspond to the pixels in the display device one-to-one; or
each of the modulating zones corresponds to a plurality of pixels in the display device and modulates a phase of the light wave in each pixel by associating with an optical path difference.

11. The holographic display apparatus of claim 10, wherein modulation angles of phases in two adjacent modulating zones during light modulation are different from each other.

12. The holographic display apparatus of claim 10, wherein a phase modulation angle of a light wave in each of the modulating zones of the phase-controlling plate is fixed.

13. The holographic display apparatus of claim 10, wherein a phase modulation angle of a light wave in each of the modulating zones of the phase-controlling plate is changeable.

14. The holographic display apparatus of claim 1, wherein the phase-controlling plate is a grating phase-controlling plate, an optical-layer-thickness-type phase-controlling plate, or a liquid crystal phase-controlling plate.

15. A method for display by using the holographic display apparatus of claim 1, comprising:
modulating the amplitude of the light wave by using the display device; and
modulating the phase of the light wave by using the phase-controlling plate.

16. The method of claim 15, wherein
the light-emitting component of the display device is a back light source emitting coherent reference light, and an amplitude of the coherent reference light is modulated by an optical switch device disposed on a light emergence side of the back light source.

17. The method of claim 16, wherein the optical switch device comprises:
an upper substrate and a lower substrate, which are disposed oppositely, and
a micro-electromechanical system, which is disposed between the upper substrate and the lower substrate.

18. The method of claim 16, wherein the optical switch device comprises:
an opposite substrate and an array substrate, which are disposed oppositely,
a liquid crystal layer, which is disposed between the opposite substrate and the array substrate,
an upper polarizer, which is disposed above the opposite substrate, and
a lower polarizer, which is disposed below the array substrate.

19. The method of claim 15, wherein the display device comprises an electroluminescent display panel, and an antireflecting polarizer is disposed on a light emergence side of the electroluminescent display panel, wherein the antireflecting polarizer is the phase-controlling plate.

20. The method of claim 15, wherein the phase-controlling plate comprises a plurality of modulating zones independent from each other, and
the modulating zones correspond to the pixels in the display device one-to-one; or
each of the modulating zones corresponds to a plurality of pixels in the display device and modulates a phase of the light wave in each pixel by associating with an optical path difference.
